(19) United States
(12) Patent Application Publication
(10) Pub. No.: US 2006/0294452 A1
(43) Pub. Date: Dec. 28, 2006

(54) System and method for managing document data, image forming apparatus and recording medium

(75) Inventor: Yukinori Matsumoto, Amagasaki-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/371,948

(22) Filed: Mar. 10, 2006

(30) Foreign Application Priority Data
Jun. 27, 2005 (JP) 2005-186875

(51) Int. Cl. G06F 17/21

(52) U.S. Cl. 715/500

(57) ABSTRACT

A system and method are provided that are capable of managing data of documents such as materials and data of information that is written into the documents in a user-friendly manner compared to conventional systems and methods. An image forming apparatus is provided with an original document registration process portion for performing a process of entering original document data used for reproducing an image of an original document, an additional information registration process portion for performing a process of entering additional data used for reproducing an image showing additional information that is information written into the document and of setting an access privilege and a document database for memorizing original document data of the entered document and additional data of the additional information for the document and additional information access privilege data indicating the set access privilege of the additional information in association with one another.

This application is based on Japanese Patent Application No. 2005-186875 filed on Jun. 27, 2005, the contents of which are hereby incorporated by reference.

### BACKGROUND OF THE INVENTION

1. Field of the Invention

The present invention relates to a server for managing document data and more particularly to an image forming apparatus having a server function.

2. Description of the Related Art

Various types of information have recently been digitized and saved. This is because saving information in the form of electronic data provides the following advantages: 1. Space-saving of locations for storing information records is realized since electromagnetic recording media such as CD-ROMs or hard disk drives can record much more data than paper. 2. Information can be shared easily by using a network server. 3. Information leakage can be prevented even in the event that information records are stolen, because data can be encrypted readily.

Some companies try to scan information that is conventionally kept in the form of paper to digitize the information for storage, then to discard paper on which the information is written, so that the companies can enjoy the advantages described above.

Scanners are widely used to convert information written on paper into electronic data. There is proposed a method of applying a scanner as described in Japanese Unexamined Patent Publication No. 11-272654. The method makes it possible to extract contents added to a page space where contents of an electronic file document are printed.

Meanwhile, mobile terminals such as note personal computers and PDAs (Personal Digital Assistant) have recently become widespread. Accordingly, instead of writing notes on paper media such as notebooks, the number of people is increasing who input notes into portable terminals to save the notes in the form of electronic data. Many people, however, still make notes on paper media which probably will continue to be helpful in making notes. The paper media do not need to be turned the power on differently from the case of mobile terminals, so that notes can be made quickly. Further, in the case of the paper media, memorandums including sentences, symbols, formula, illustrations and charts can be readily made only with a pen without switching application software or tools.

In addition to these advantages, the paper media are advantageous in the following situation: When attendances at a meeting are given materials that are printed on a paper medium, they can freely write memorandums such as ideas or remarks of speakers during the meeting in blank spaces adjacent to the related part or between lines of the material that is distributed to each of the attendances. Such writing makes the relationship between the memorandum contents and the material contents easier to understand later.

Concerning such paper materials that are distributed to plural persons and have written information such as memorandums, the method described in Japanese Unexamined Patent Publication No. 11-272654 can be applied to extract the memorandum part to convert the same into electronic data for management. Further, according to the method described in the Publication, with respect to one material, it is possible to collect electronic data of information that is additionally written by each of the persons.

It should be understood that the details of the material for the meeting can be known by all the attendances since they are given the material. The information, however, such as memorandums and others that are written into the material by each of the attendances should not necessarily be shared by all the attendances.

For example, a case may arise in which memorandums commenting on the material contents, personal information, know-how information or the like should be disclosed to predetermined person(s) and be concealed from the other person(s). In addition, when information that is additionally written is collected from a great number of people, sharing the information by all the attendances makes it difficult to find out necessary information among all pieces of the information. The same is true of documents other than the material for the meeting. The conventional method, however, as described in Japanese Unexamined Patent Publication No. 11-272654 is incapable of solving these problems sufficiently.

### SUMMARY OF THE INVENTION

The present invention is directed to solve the problems pointed out above, and therefore, an object of the present invention is to provide a system and a method for managing data of documents such as materials and data of information that is written into the documents in a user-friendly manner compared to conventional systems and methods.

According to one aspect of the present invention, a document data management system includes a first data entry process portion for performing a process for entering original image reproduction data used for reproducing an image of an original of a document, a second data entry process portion for performing a process for entering additional information image reproduction data used for reproducing an image showing additional information that is information added to the document, a setting portion for setting an access privilege of the additional information, and a memorizing portion for memorizing, in association with one another, the original image reproduction data thus entered of the document, the additional information image reproduction data thus entered of the additional information for the document and access privilege data indicating the access privilege thus set of the additional information.

Preferably, the document data management system further includes a presenting portion for presenting the additional information corresponding to the additional information image reproduction data that are memorized in the memorizing portion in order to prompt a user to select, the additional information to be presented being associated with the document specified by the user and the additional information to be presented being capable of being accessed by the user, a combined image generating portion for generating a combined image that is an image in which one or more images of one or more pieces of the additional information are overlaid on the image of the original of the document based on the original image reproduction data of the document specified by the user and the additional information image reproduction data of the one or more pieces of the additional information selected by the user, and an output process portion for performing a process for outputting the combined image thus generated.

In the present invention, an “original of a document” means a document where no additional information is written after the document is completed. The original corresponds to, for example, a document that is to be distributed to attendances at a meeting and is in a state just before being distributed. Alternatively, the original corresponds to paper of model form that is used for various applications and is in a state before being written in by an applicant.

The present invention makes it possible to manage data of documents such as materials and data of information that is written into the documents in a user-friendly manner compared to conventional systems and methods.

These and other characteristics and objects of the present invention will become more apparent by the following descriptions of preferred embodiments with reference to drawings.

### BRIEF DESCRIPTION OF THE DRAWINGS

FIG. 1 is a diagram showing an example of an overall configuration of a document data sharing system.

FIG. 2 is a diagram showing an example of a hardware configuration of an image forming apparatus.

FIG. 3 is a diagram showing an example of a structure of a control panel.

FIG. 4 is a diagram showing an example of a functional structure of the image forming apparatus.

FIGS. 5(a)-5(c) are diagrams for exemplifying a relationship between an original document and additional information.

FIG. 6 is a flowchart showing an example of a flow of a process for entering and saving an original document.

FIG. 7 shows an example of an original document scan setting screen.

FIG. 8 is a diagram showing an example of a configuration of an additional information registration process portion.

FIG. 9 is a flowchart showing an example of a flow of a process for entering and saving additional information.

FIG. 10 shows an example of an additional information scan setting screen.

FIG. 11 is a diagram showing an example of data stored in a document database.

FIG. 12 is a diagram showing an example of a configuration of an output image generating portion.

FIG. 13 is a flowchart showing an example of a flow of a document image reproduction process.

FIG. 14 shows an example of a display document setting screen.

FIG. 15 shows an example of a layer setting screen.

FIG. 16 is a flowchart showing an example of a flow of the entire process in the image forming apparatus.

FIG. 17 is a diagram showing an example of a functional structure of an image forming apparatus.

FIG. 18 is a diagram showing an example of a software configuration of a terminal.

FIG. 19 is a diagram showing an example of a functional structure of the terminal.

FIG. 20 shows an example of an additional information setting screen.

FIG. 21 shows an example of an object creation adding screen.

FIG. 22 is a diagram showing an example of data stored in a document database.

FIGS. 23(a) and 23(b) are diagrams exemplifying a method for generating a document reproduced image.

### DESCRIPTION OF THE PREFERRED EMBODIMENTS

### First Embodiment

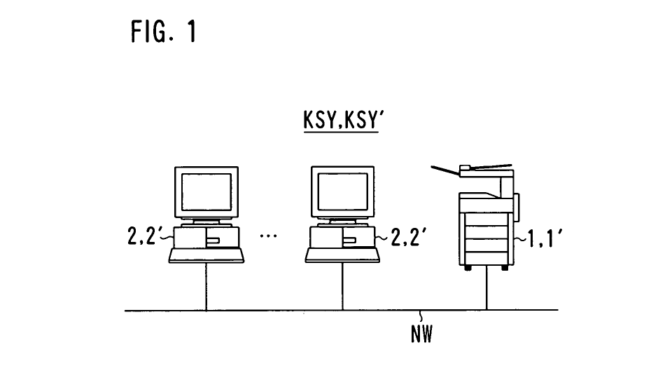

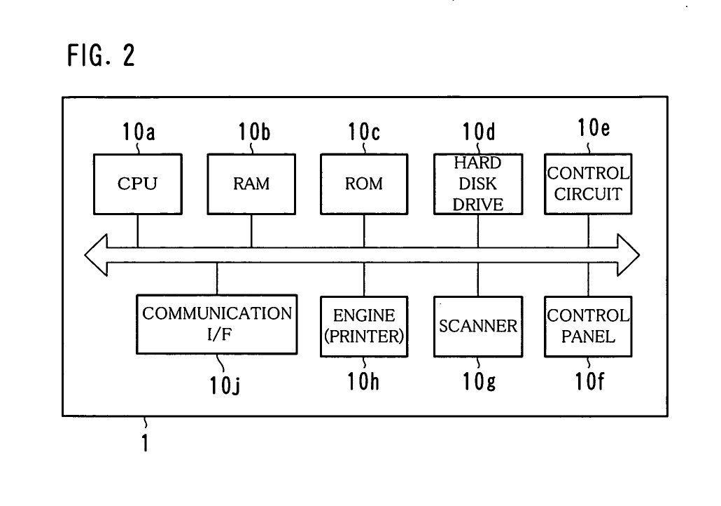

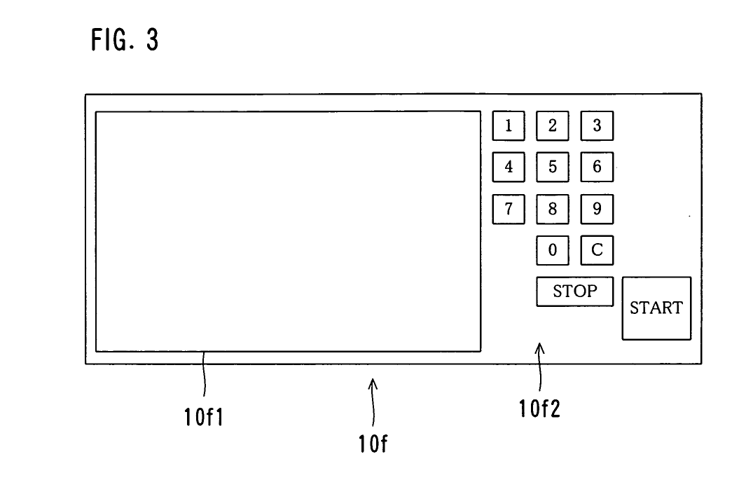

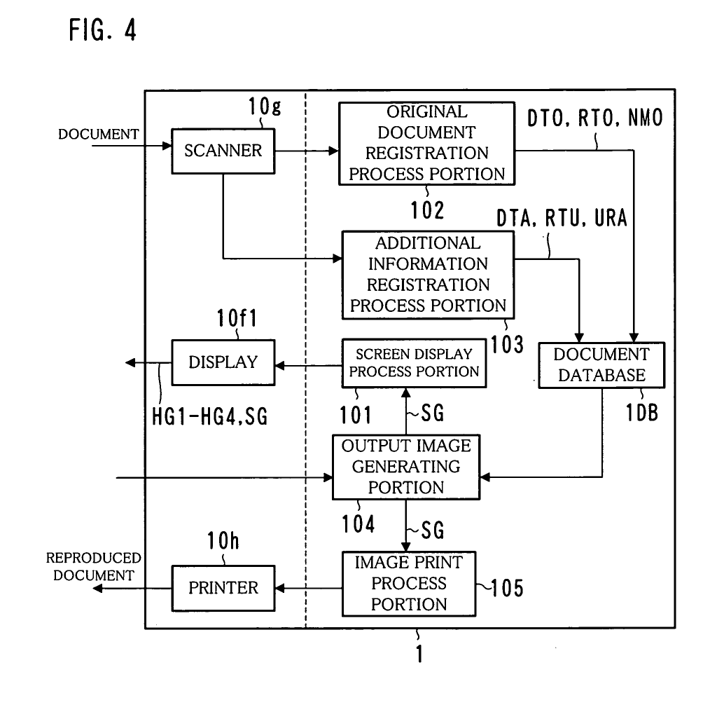

FIG. 1 is a diagram showing an example of an overall configuration of a document data sharing system KSY, FIG. 2 is a diagram showing an example of a hardware configuration of an image forming apparatus 1, FIG. 3 is a diagram showing an example of a structure of a control panel 10f and FIG. 4 is a diagram showing an example of a functional structure of the image forming apparatus 1.

Referring to FIG. 1, the document data sharing system KSY includes the image forming apparatus 1, terminals 2 and a communication line NW. The image forming apparatus 1 and each of the terminals are connected to each other via the communication line NW that can be a LAN line, the Internet, a public line or a private line.

The document data sharing system KSY is installed in an organization such as a public office, a company or a school. The document data sharing system KSY enables plural users to share data of a document.

The image forming apparatus 1 is an image processor in which functions of a copier, a scanner, a fax machine, a network printer or others are consolidated. The image forming apparatus 1 is sometimes called a multifunction device or a multifunction peripheral (MFP).

“Network printing” is a function for receiving image data from the terminal 2 to print an image on a sheet of paper. Such a function is sometimes called a “network printer functions, “PC print function” or the like.

“Document server” is a function for managing data of a document made up of an object such as a text, a photograph, an illustration or a chart. The image forming apparatus 1 according to the present invention has a function of digitizing information that is added to an original document by a user to manage the data, in addition to conventional functions. This will be sequentially described later.

Referring to FIG. 2, the image forming apparatus 1 includes a CPU 10a, a RAM 10b, a ROM 10c, a hard disk drive 10d, a control circuit 10e, a control panel 10f, a scanner 10g, a printer 10h and a communication interface

The scanner 10g is a device for optically reading an image such as a photograph, a character, a picture or a chart that is depicted on a sheet of paper to generate image data.

The printer 10h is a device for printing an image on a sheet of paper depending on user's commands based on an image captured by the scanner 10g or image data received from the terminal 2.

Referring to FIG. 3, the control panel 10f includes a display 10f1 and a control button unit 10f2 with plural control buttons.

The control button unit 10f2 includes plural keys for entering numerals, characters, symbols or others, a sensor for recognizing pressed keys and a transmission circuit for transmitting a signal indicating a recognized key to the CPU 10a.

The display 10f1 serves to display a screen for giving a message or directions to a user who operates this image forming apparatus 1, a screen for prompting the user to enter types and conditions of desired processes and a screen for displaying an image formed by the image forming apparatus 1 and process results. A touch panel is used as the display 10f1 in this embodiment. Accordingly, the display 10f1 has a function of detecting a position on the touch panel that is touched by a finger of the user to transmit a signal indicative of the detection result to the CPU 10a.

Thus, the control panel 10f plays a role as a user interface for a user who directly operates the image forming apparatus 1. Note that on the terminal 2 are installed application programs for issuing commands to the image forming apparatus 1 and a driver. Accordingly, a user can operate the image forming apparatus 1 remotely using the terminal 2. A personal computer, a workstation or the like is used as the terminal 2.

The communication interface 10j shown in FIG. 2 is a Network Interface Card (NIC), a modem or others.

The control circuit 10e is a circuit for controlling devices such as the hard disk drive 10d, the scanner 10g, the printer 10h, the communication interface 10j and the control panel 10f.

The hard disk drive 10d stores programs and data for realizing functions of a screen display process portion 101, an original document registration process portion 102, an additional information registration process portion 103, an output image generating portion 104, an image print process portion 105 and a document database 1DB, all of which are shown in FIG. 4. These programs are read out to the RAM 10b as required and the programs are executed by the CPU 10a. All or part of these programs or data may be memorized in the ROM 10c. Alternatively, all or part of the functions shown in FIG. 4 may be realized by the control circuit 10e.

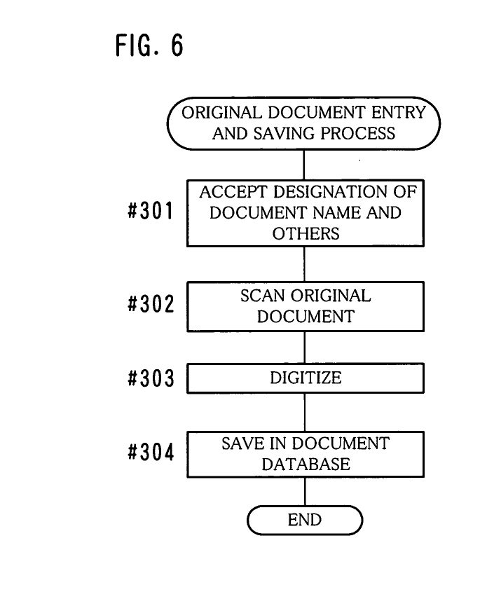

Note that the CPU 10a performs a control operation for processes of flowcharts shown in FIGS. 6, 9, 13 and 16 that will be described later.

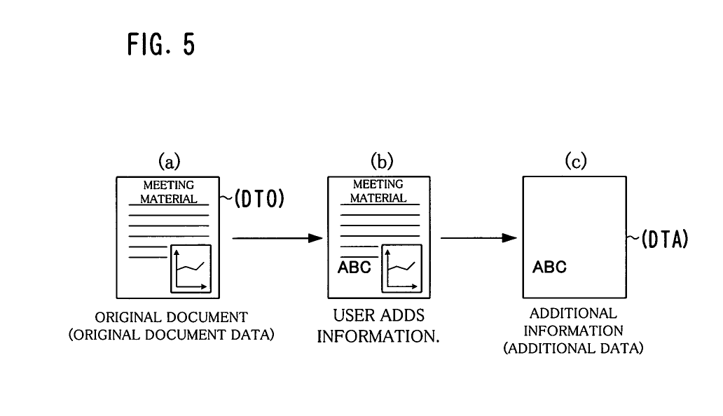

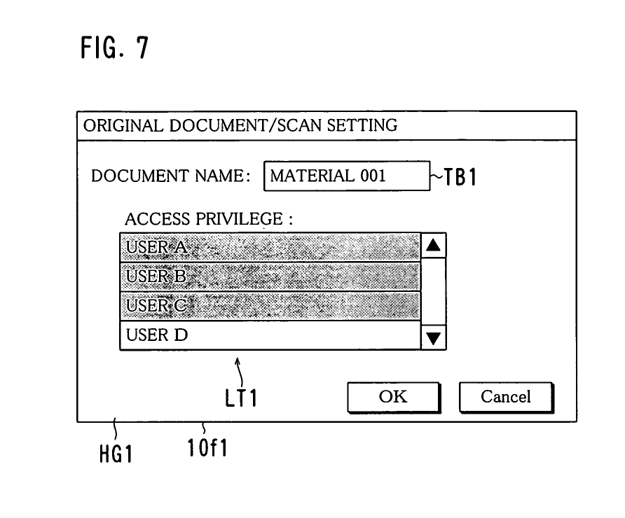

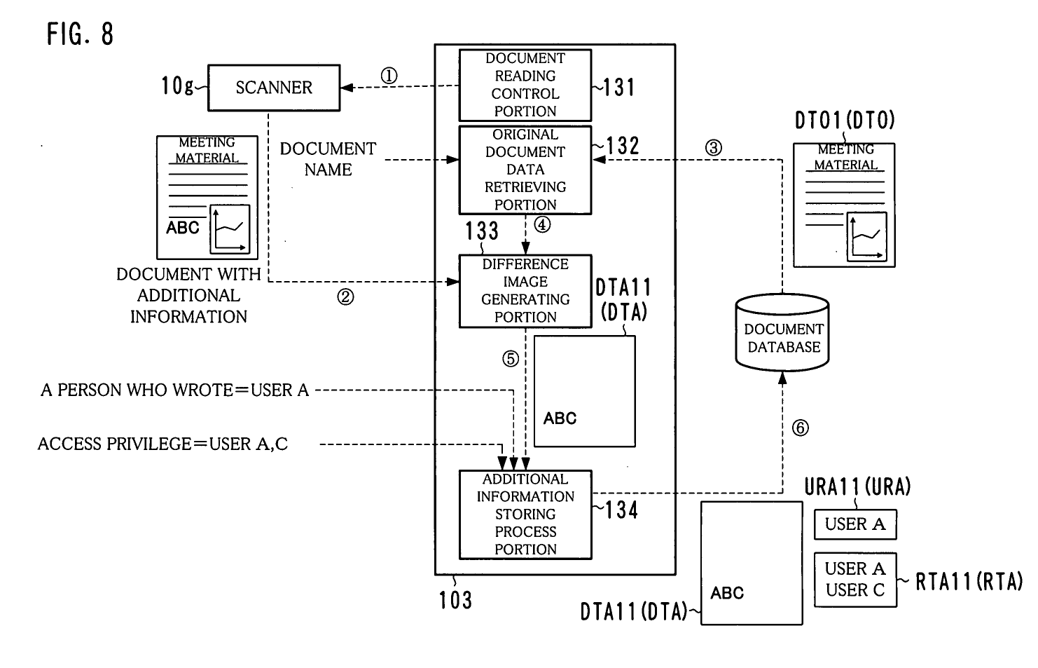

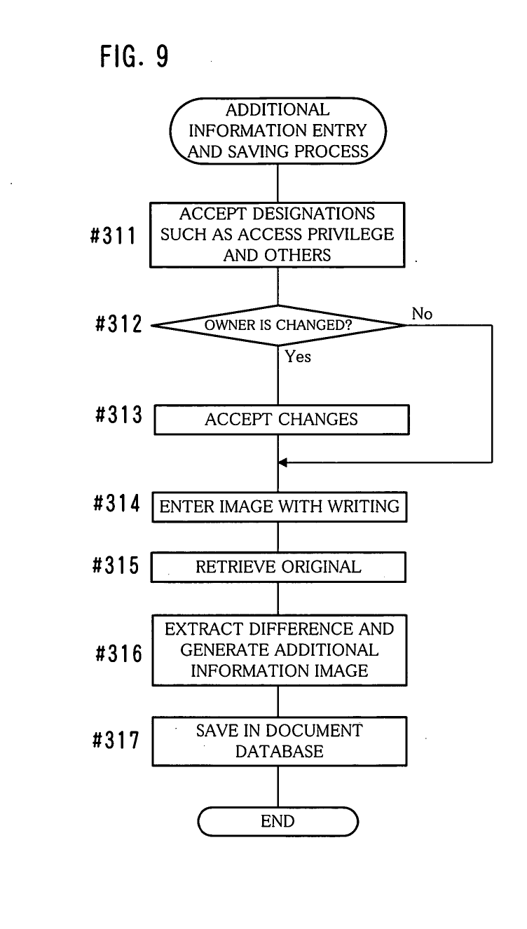

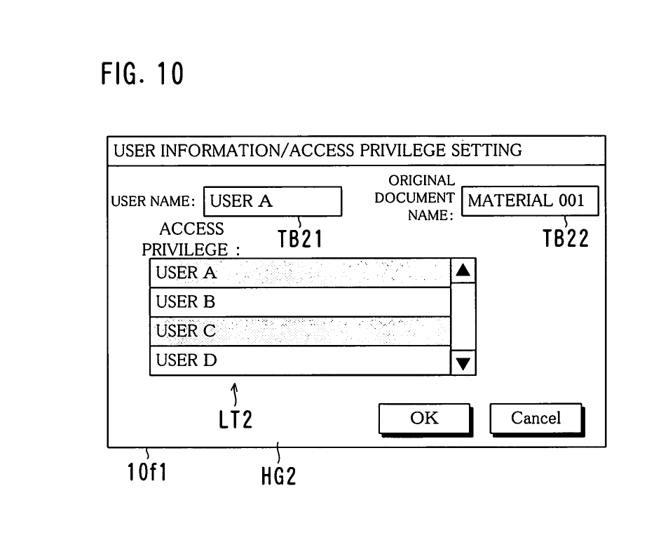

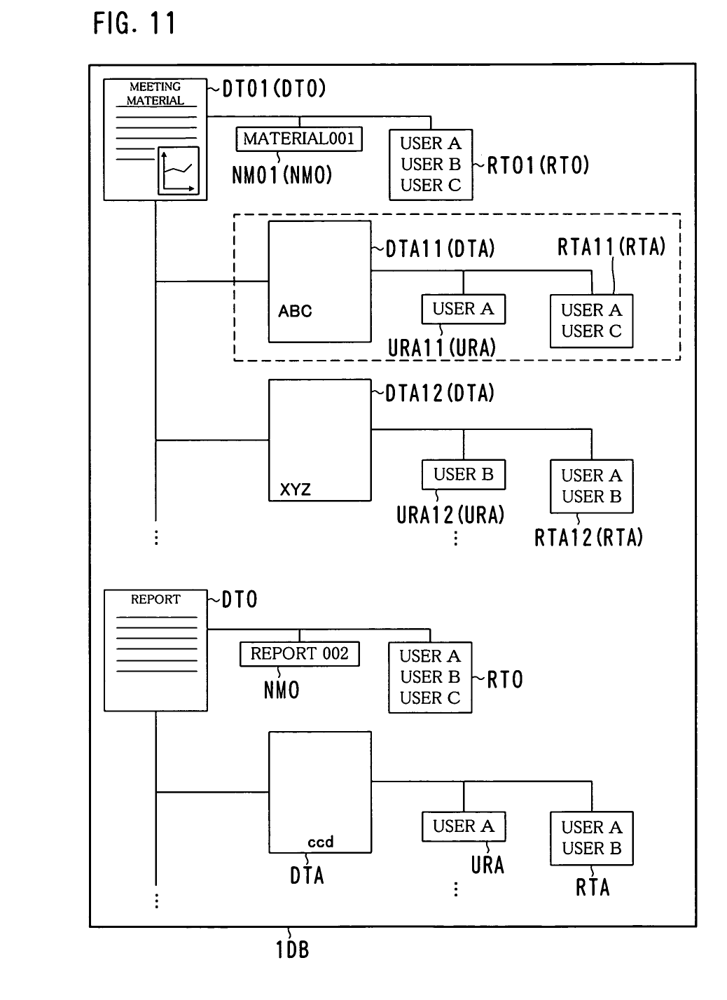

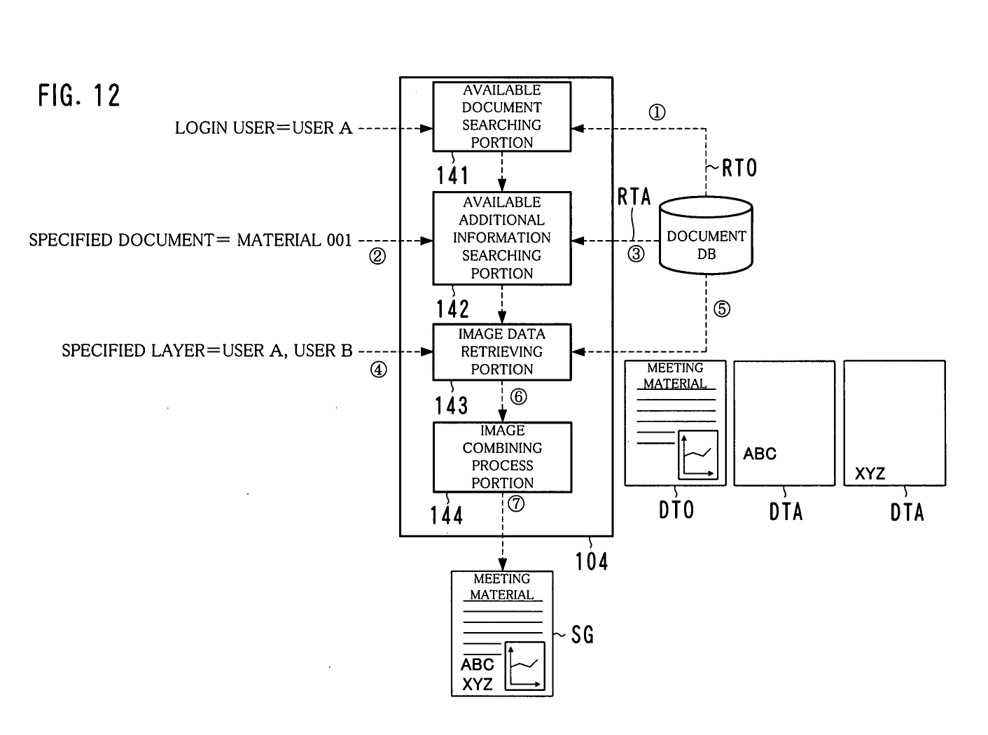

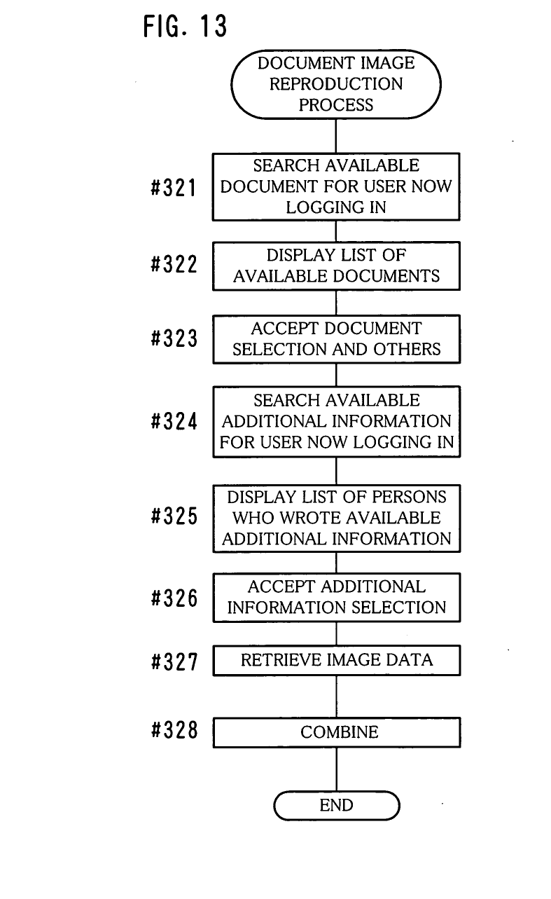

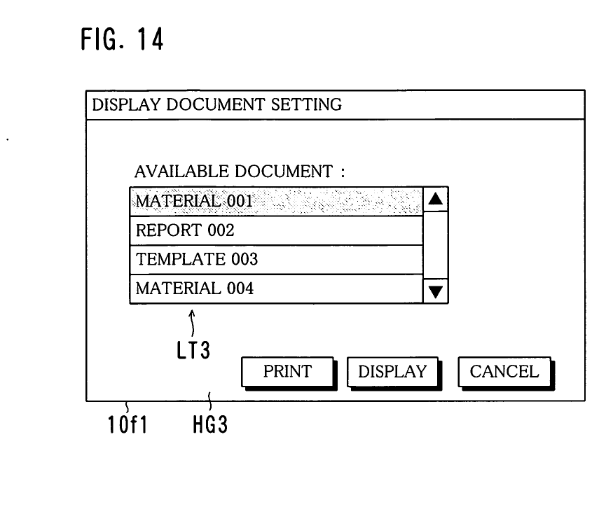

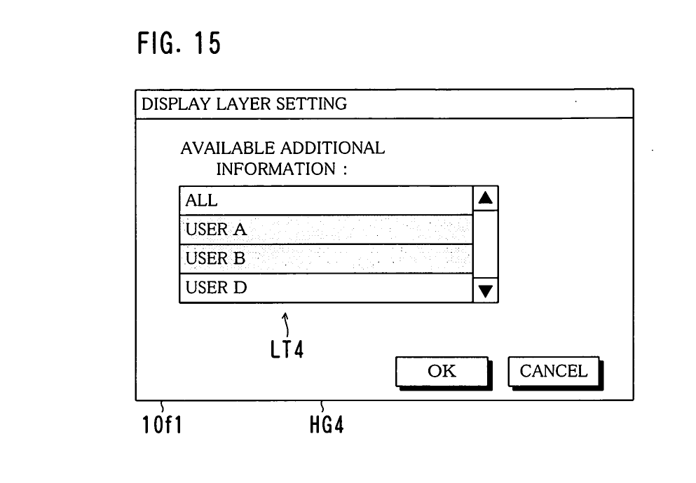

FIGS. 5(a)-5(c) are diagrams for exemplifying a relationship between an original document and additional information, FIG. 6 is a flowchart showing an example of a flow of a process for entering and saving an original document, FIG. 7 shows an example of an original document scan setting screen HG1, FIG. 8 is a diagram showing an example of a configuration of the additional information registration process portion 103, FIG. 9 is a flowchart showing an example of a flow of a process for entering and saving additional information, FIG. 10 shows an example of an additional information scan setting screen HG2, FIG. 11 is a diagram showing an example of data stored in the document database 1DB, FIG. 12 is a diagram showing an example of a configuration of the output image generating portion 104, FIG. 13 is a flowchart showing an example of a flow of a document image reproduction process, FIG. 14 shows an example of a display document setting screen HG3 and FIG. 15 shows an example of a layer setting screen HG4.

Here, detailed descriptions are given of functions and process contents of the portions included in the image forming apparatus 1 shown in FIG. 4.

The screen display process portion 101 makes the display 10f1 of the control panel 10f display a predetermined screen at predetermined timing. When none logs in to the image forming apparatus 1, for example, a login screen that is used for entering a user name and a password is displayed as a standby screen for operations. After a user logs in, screens that will be described later one by one are displayed on the display 10f1 depending on user's operation or a process result. When a user operates, however, the image forming apparatus 1 remotely using the terminal 2, the screen display process portion 101 performs a display process of a screen by transmitting screen data to the terminal 2 used by the user.

The document database 1DB saves and manages original document data DTO, additional data DTA and data of information on attributes of the original document data DTO and the additional data DTA. Here, an “original document” means a document where no additional information is written after the document is completed. In other words, the original document is a source document or an original text. The original document corresponds to, for example, a material that is to be distributed to attendances at a meeting and is in a state just before being distributed. Further, the original document corresponds to paper of model form that is used for various applications. The “original document data” are one used for reproducing an image of the original document to display or print the image. The “additional data” are one used for reproducing an image of information that is additionally written into the original document, i.e., memorandums (notes) or the like.

For example, assume that a user additionally writes information with a writing instrument such as a pen or others as shown in FIG. 5(b) into an original document as shown in FIG. 5(a). In this case, data for reproducing information of the added portion as shown in FIG. 5(c) are the additional data DTA. Hereinafter, information that is additionally written is sometimes referred to as “additional information”. A TIFF, PDF, GIF or bitmap format is used as a format of the original document data DTO and the additional data DTA.

The original document registration process portion 102 shown in FIG. 4 performs a process for registering data pertaining to an original document in the image forming apparatus 1, for example, in the procedure as shown in FIG. 6. When a user performs a predetermined operation on the control panel 10f, the screen display process portion 101 displays the original document scan setting screen HG1 as shown in FIG. 7 on the display 10f 1.

Here, the user specifies a name of an original document to be saved in the image forming apparatus 1, i.e., a document name in a text box TB1. Further, the user specifies a user who is allowed to use the original document, i.e., a user who is allowed to be given an access privilege of the original document, from an access privilege specification list LT1 by pressing a line corresponding to the user to be specified. Specifying plural users is also possible. A background color of the pressed line is changed to a gray or the like, which shows that the user corresponding to the pressed line is designated. Pressing the line again unspecifies the line and the original document scan setting screen HG1 returns to a state before the designation. A scroll bar up arrow and a scroll bar down arrow, which are provided on the right side of the access privilege specification list LT1, are used to roll up and down the screen, so that users who are not currently displayed on the access privilege specification list LT1 can be displayed. Other lists that will be described later can be operated in the same manner. After completing those specifications, a sheet of the original document is set on a document handler to press the “OK” button.

Responding to this operation, the original document registration process portion 102 accepts contents specified by the user (#301 shown in FIG. 6), controls the scanner 10g to make the same scan the sheet of the original document that is set on the document handler (#302) and obtains image data of the original document (#303). Then, the original document registration process portion 102 saves the image data thus obtained as the original document data DTO in the document database 1DB. Further, the original document registration process portion 102 saves document name data NMO indicative of the document name specified by the user and original access privilege data RTO indicative of a privilege of an access to the original document in association with the original document data DTO (#304).

Referring to FIG. 8, the additional information registration process portion 103 shown in FIG. 4 includes a document reading control portion 131, an original document data retrieving portion 132, a difference image generating portion 133 and an additional information storing process portion 134. The additional information registration process portion 103 performs a process for registering data on additional information such as additional data DTA in the image forming apparatus 1. Hereinafter, descriptions are provided of process contents of all the portions of the additional information registration process portion 103 with reference to FIGS. 8, 9 and others.

When a user performs a predetermined operation on the control panel 10f, the screen display process portion 101 displays the additional information scan setting screen HG2 shown in FIG. 10 on the display 10f1.

Here, the user performs a specifying operation relating to a document into which additional information such as memorandums to be saved in the image forming apparatus 1 is additionally written (hereinafter referred to as a document with additional information). The user specifies in a text box TB21 a user name of a user who wrote the additional information (hereinafter referred to as a person who wrote). For simplicity, however, an identifier for identifying a user who is now logging in to the image forming apparatus 1, which is a user name in the present embodiment, is automatically stored as a default value in the text box TB21. In other words, a user name of a user who is currently operating the control panel 10f is stored in the text box TB21. When a user intends to designate him/her as a person who wrote, he/she retains contents specified in the text box TB21. When the user intends to designate another user, he/she designates a user name of the other user in the text box TB21.

It is possible to designate a provider of additional information, instead of a person who wrote, in the text box TB21. For example, when a user additionally writes an opinion of a speaker as additional information during a meeting, the user may designate a user name of the speaker in the text box TB21. Other than these, it is also possible to specify a user name of a person who should manage additional information in the text box TB21.

The user specifies in a text box TB22 an identifier of an original document of the document with additional information, i.e., a document name in this embodiment. Further, the user specifies in an access privilege given user list LT2 a user who is allowed to use the additional information included in the document with additional information, i.e., a user who is allowed to be given an access privilege of the additional information. Specifying plural users is also possible. After completing those designations, a sheet of the document with additional information is set on the document handler to press the “OK” button.

Responding to this operation, contents designated by the user are accepted in the image forming apparatus 1 (#311 shown in FIG. 9). Each of the portions included in the additional information registration process portion 103 performs each process of steps #314 through #317. When a user name specified in the text box TB21 is changed from the default value (Yes in #312), a user name after the change is accepted (#313).

The document reading control portion 131 controls the scanner 10g to make the same scan the sheet of the document with additional information that is set on the document handler and obtains image data of the document with additional information (circled numbers 1 and 2 in FIG. 8 and #314 in FIG. 9). The original document data retrieving portion 132 retrieves original document data DTO having the document name specified by the user from the document database 1DB (circled numbers 3 and 4 in FIG. 8 and #315 in FIG. 9) in series or in parallel with the process in step #314.

The difference image generating portion 133 extracts a difference between an image of the document with additional information and an image of the original document based on the image data of the document with additional information and the original document data DTO to generate image data of a difference image (circled number 5 in FIG. 8 and #316 in FIG. 9). The image of the document with additional information includes the entire image of the original document and further an image such as handwritten notes (an image of the additional information). Accordingly, the difference image shows additional information and the image data thereof are regarded as the additional data DTA.

The additional information storing process portion 134 saves the additional data DTA thus generated in the document database 1DB. Further, the additional information storing process portion 134 saves user data URA indicative of the user name of the person who wrote that is specified by the user in the additional information scan setting screen HG2 and additional information access privilege data RTA indicative of a privilege of an access to the additional information in association with the additional data DTA (circled number 6 in FIG. 8 and #317 in FIG. 9). Further, the additional data DTA, the user data URA and the additional information access privilege data RTA are correlated to the original document data DTO of the original document that is specified in the additional information scan setting screen HG2.

Referring to FIG. 8, for example, when additional data DTA11, user data URA11 and additional information access privilege data RTA11 are obtained based on original document data DTO1 and a document with additional information for the original document, all the data thus obtained are saved in association with the original document data DTO1 as shown in FIG. 11.

An original document can be duplicated and distributed to many users. Accordingly, a case may arise where each of the plural users intends to write additional information and to save data pertaining to the additional information in the image forming apparatus 1. This may cause a case where, with respect to the original document data DTO for one original document, plural sets of the additional data DTA, the user data URA and the additional information access privilege data RTA are saved in the document database 1DB.

Referring to FIG. 12, the output image generating portion 104 shown in FIG. 4 includes an available document searching portion 141, an available additional information searching portion 142, an image data retrieving portion 143 and an image combining process portion 144. The output image generating portion 104 performs a process for reproducing an image of a document that a user intends to output.

As described earlier, the document database 1DB saves data of an original document and data of additional information that is additionally written into the original document. A user can select one original document and one piece of additional information that is written thereinto from the document database 1DB to reproduce a document with additional information. Alternatively, a user can select one original document and plural pieces of additional information that is written thereinto to reproduce a document such as one that has plural notes by plural users on one original document.

Hereinafter, descriptions are given of process contents of all the portions included in the output image generating portion 104 with reference to FIGS. 12, 13 and others.

When a user performs a predetermined operation on the control panel 10f, the available document searching portion 141 searches an original document that can be used by a user who is now logging in, i.e., a user who is currently performing operations, based on the original access privilege data RTO of the original document data DTO of each original document saved in the document database 1DB (circled number 1 in FIG. 12 and #321 in FIG. 13). If a user name of the user is specified in the original access privilege data RTO, it is determined that an original document corresponding to the original access privilege data RTO can be used by the user. Then, the available document searching portion 141 instructs the screen display process portion 101 to perform a process for displaying the display document setting screen HG3, which is shown in FIG. 14, including an available document list LT3 indicating document names of the searched original documents (#322).

After the display document setting screen HG3 is displayed, the user selects one original document to be the basis of a desired document from the available document list LT3. After the selection, the user further selects a method for outputting the document. More specifically, the user presses the “print” button when he/she intends to output a document in the form of printing and presses the “display” button for display on the display 10f1. Then, the image forming apparatus 1 accepts contents that are selected by the user (circled number 2 in FIG. 12 and #323 in FIG. 13).

The available additional information searching portion 142 searches additional information that the user is allowed to use based on the additional information access privilege data RTA of all pieces of the additional information of the original document selected by the user (circled number 3 in FIG. 12 and #324 in FIG. 13). If the user name of the user is specified in the additional information access privilege data RTA, it is determined that the user is allowed to use additional information corresponding to the additional information access privilege data RTA. Then, the available additional information searching portion 142 instructs the screen display process portion 101 to perform a process for displaying the layer setting screen HG4, which is shown in FIG. 15, including an available additional information list LT4 (#325). The available additional information list LT4 shows a person who wrote the searched additional information.

After the layer setting screen HG4 is displayed, the user presses a line corresponding to a user name of the person to select additional information to be outputted together with the original document that is selected on the display document setting screen HG3 as described above. Selecting plural pieces of additional information is also possible. Further, selecting all pieces of additional information that can be used is also possible by pressing a line marked “ALL”. After the selection, the user presses the “OK” button. Then, the image forming apparatus 1 accepts contents that are specified by the user (circled number 4 in FIG. 12 and #326 in FIG. 13).

The image data retrieving portion 143 retrieves from the document database 1DB original document data DTO of the original document that is selected by the user on the display document setting screen HG3 and additional data DTA of the additional information that is selected by the user on the layer setting screen HG4 (circled numbers 5 and 6 in FIG. 12 and #327 in FIG. 13).

The image combining process portion 144 generates an image of an original document based on the retrieved original document data DTO and generates an image of additional information based on the additional data DTA. When plural additional data DTA are retrieved, the image combining process portion 144 generates an image of additional information individually based on the additional data DTA. Then, one or more images of additional information thus generated are overlaid, like layers in drawing application, on the generated image of the original document (circled number 7 in FIG. 12 and #328 in FIG. 13). In this way, an image is reproduced in which the additional information is written into the original document. The image thus reproduced is hereinafter referred to as a “document reproduced image SG”.

Referring to FIG. 4 again, the image print process portion 105 controls the printer 10h and others so that the document reproduced image SG generated by the output image generating portion 104 is printed on a sheet of paper when the “print” button is pressed on the display document setting screen HG3. When the “display” button is pressed, the screen display process portion 101 controls the control panel 10f and others so that the document reproduced image SG is displayed on the display 10f1.

The user can perform the designations relating to reproduction and output of a document that are described with reference to FIGS. 12 and 13 remotely using the terminal 2. In this case, the image forming apparatus 1 transmits to the terminal 2 image data of the display document setting screen HG3 (see FIG. 14) and the layer setting screen HG4 (see FIG. 15) via the communication line NW, so that the terminal 2 displays the display document setting screen HG3 and the layer setting screen HG4. In addition, data indicating the contents selected by the user are also accepted via the communication line NW. When the user selects the “display” as a method for outputting the document reproduced image SG, image data thereof are transmitted to the terminal 2 to make the terminal 2 display the document reproduced image SG.

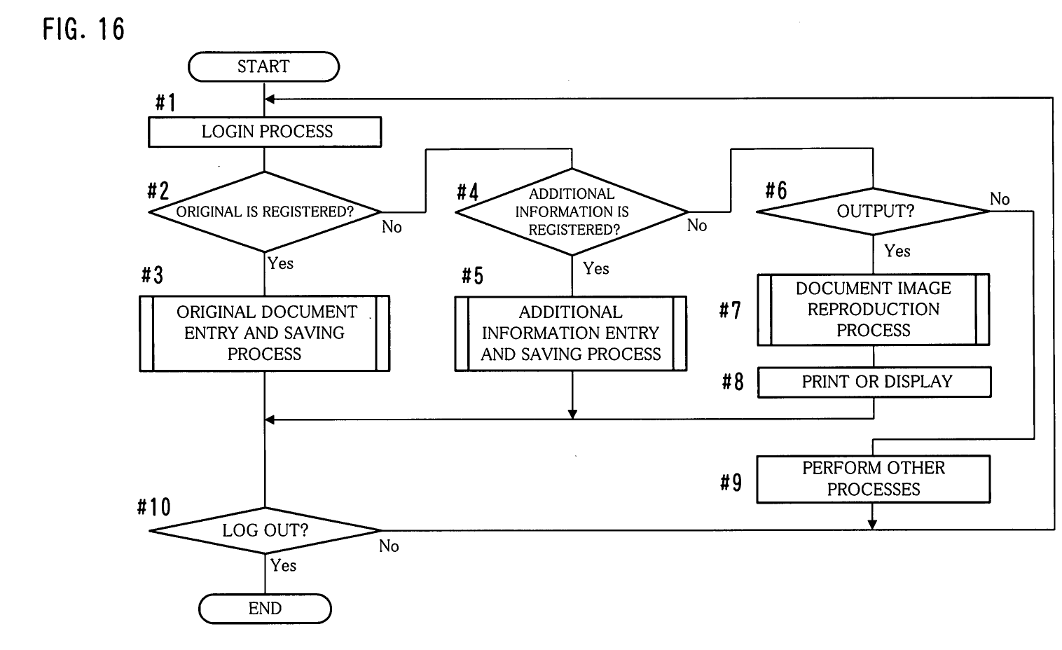

FIG. 16 is a flowchart showing an example of a flow of the entire process in the image forming apparatus 1. Next, descriptions will be provided, with reference to FIG. 16, of the flow of the entire process in the image forming apparatus 1 during a period from user's logging in to user' logging out.

When a user intends to use the image forming apparatus 1, first, he/she operates the control panel 10f or the terminal 2 to specify an identifier of his/her user account (his/her user name, for example) and his/her password. Then, the image forming apparatus 1 compares the user name and the password thus specified with a user name and a password of each user account that are registered in the existing account management database, then to perform a user authentication process. After that, when the user is verified that he/she is an authorized user, logging in of the user is permitted (#1 in FIG. 16). When an authentication server is provided in the document data sharing system KSY, the authentication server may perform the user authentication process.

When the user performs a process for making the display 10f1 display the original document scan setting screen HG1 (see FIG. 7) to save data pertaining to the original document in the image forming apparatus 1 (Yes in #2), the image forming apparatus 1 performs a process for entering and saving such data (#3). The procedure of these processes is as described earlier with reference to FIG. 6 and others.

When the user performs a process for making the display 10f1 display the additional information scan setting screen HG2 (see FIG. 10) to save data pertaining to the additional information that is written into the original document in the image forming apparatus 1 (Yes in #4), the image forming apparatus 1 performs a process for entering and saving such data (#5). The procedure of these processes is as described earlier with reference to FIG. 9 and others.

When the user performs a process for making the display 10f1 display the display document setting screen HG3 (see FIG. 14) and the layer setting screen HG4 (see FIG. 15) to reproduce and output a document into which the additional information is written (Yes in #6), the image forming apparatus 1 overlays, like layers, an image of the additional information that is selected in the layer setting screen HG4 on an image of the original document that is selected (specified) on the document setting screen HG3, so that a document reproduced image SG is generated (#7). The procedure of the process for generating the document reproduced image SG is as described earlier with reference to FIG. 13 and others. Then, the document reproduced image SG thus generated is printed on a sheet of paper or displayed on the display 10f1 (#8).

When the user performs an operation for processes other than the processes mentioned above, i.e., for copy or fax transmission (No in #6), the image forming apparatus 1, in a conventional manner, controls all the portions so that a process specified by the user is performed (#9).

The processes from steps #2 through #9 are appropriately performed in accordance with user's operations and others during a period from user's logging in to the image forming apparatus 1 to user's logging out thereof.

According to the present invention, a user can register in the image forming apparatus 1 additional data DTA for additional information that is directly written into a sheet of a document with a pen or the like only by reading the document and an original document having no writing with a scanner. In registering the additional data DTA, an access privilege can be set to the additional data DTA of additional information such as handwritten notes or others. This makes it possible to manage the additional data DTA easily even if data for much additional information are registered for one original document or even if additional information that needs to be concealed from a predetermined user should be registered.

In the present embodiment, the image forming apparatus 1 performs all processes including a process for scanning a document, a process for managing information on an original document and information on additional information, a process for combining an image of the original document and an image of the additional information and a process for outputting an image of a document that is reproduced by the combination. However, a configuration is possible in which a part of the processes is allotted to other device for performance. For example, it is possible for a database server machine to perform the process for managing information on an original document and information on additional information. Alternatively, it is also possible for a personal computer connected to a scanner to perform the process for scanning a document.

### Second Embodiment

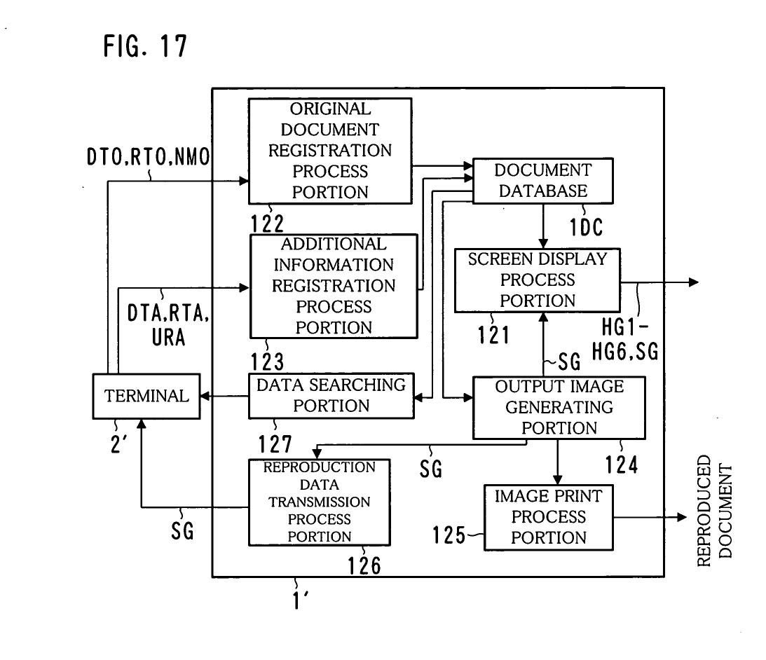

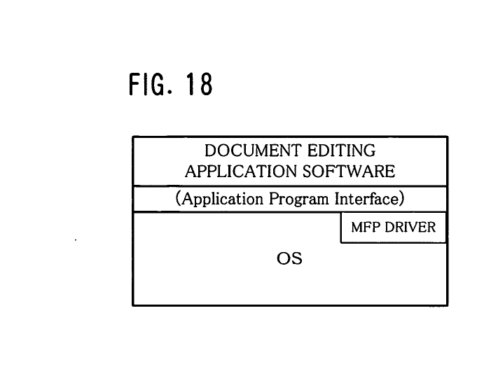

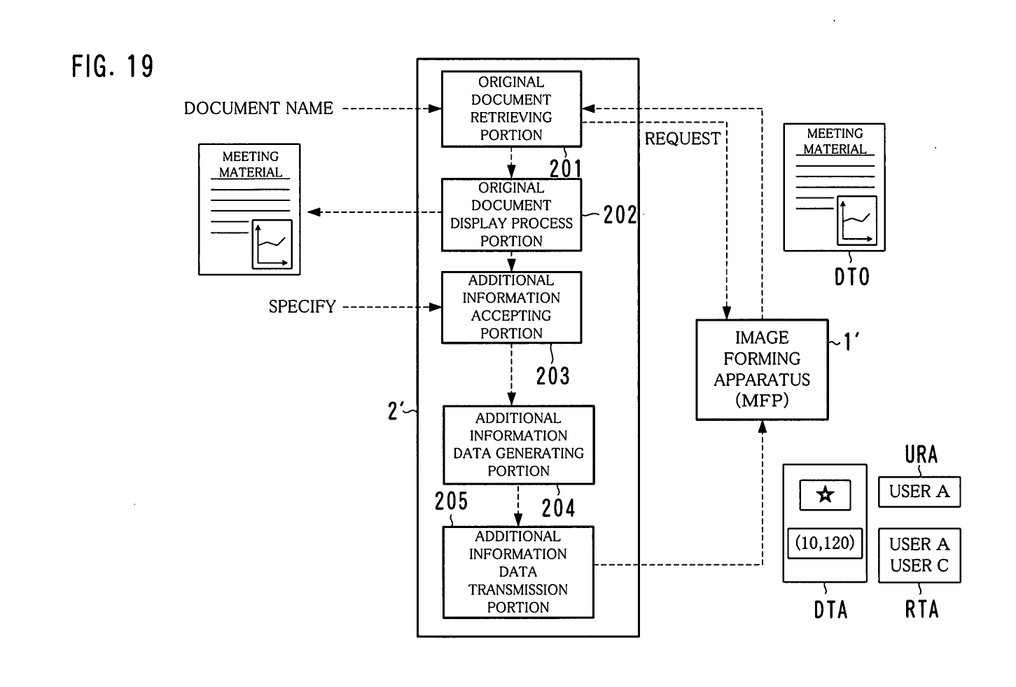

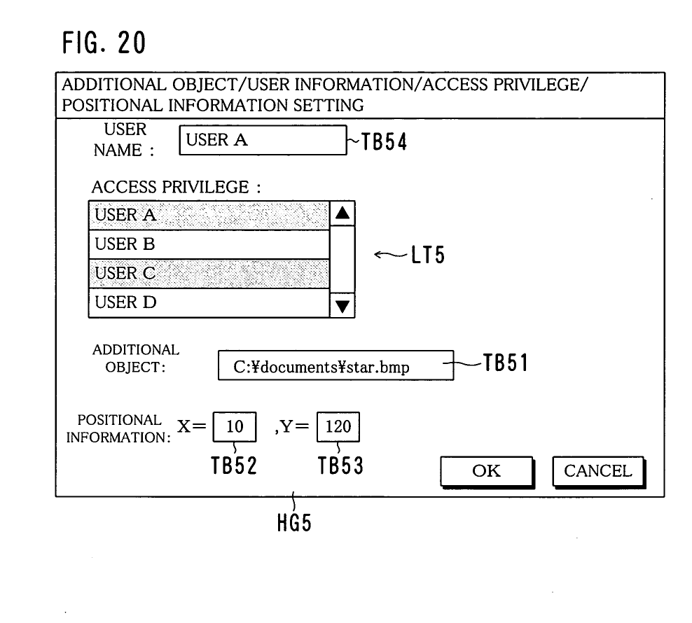

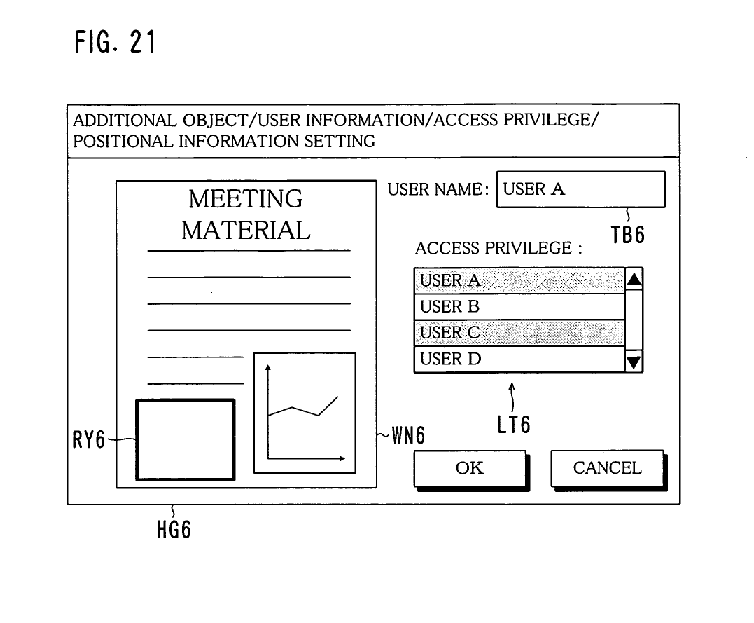

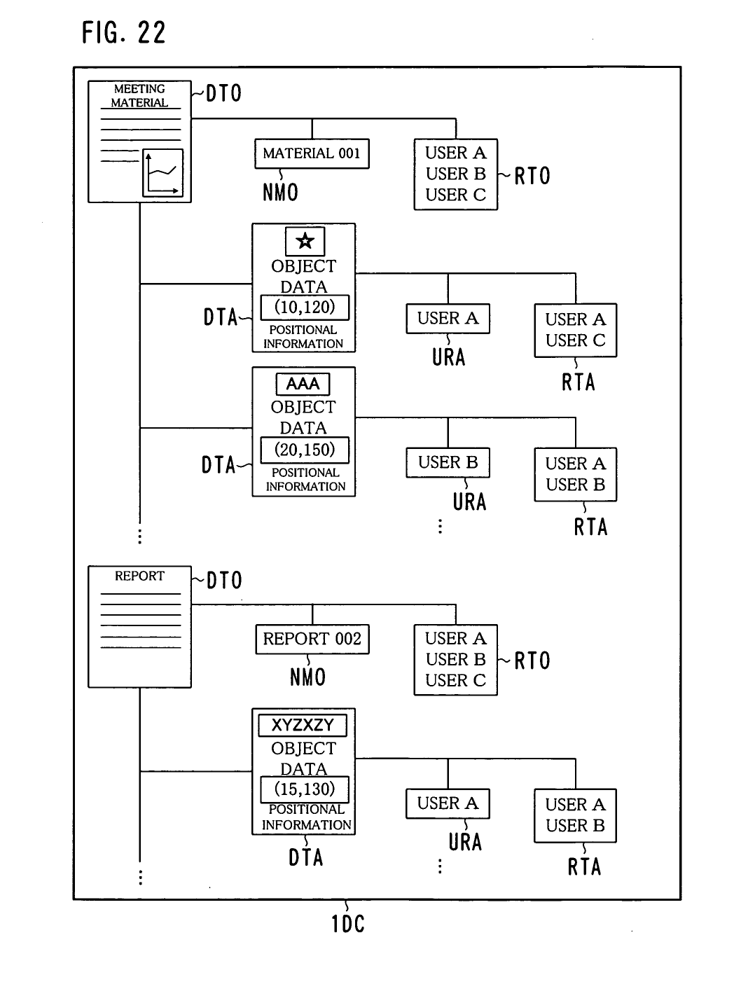

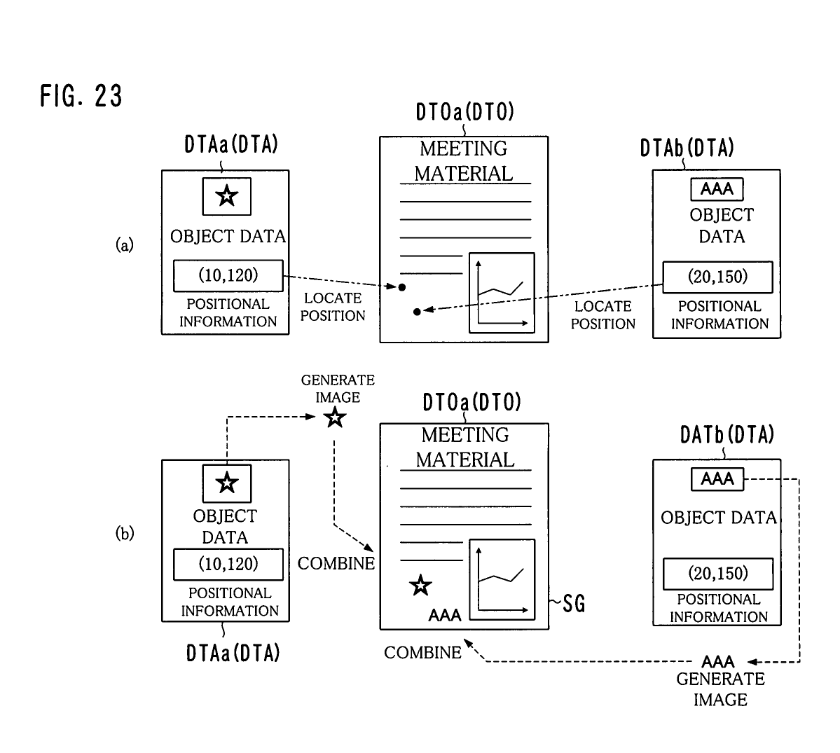

FIG. 17 is a diagram showing an example of a functional structure of an image forming apparatus 1′, FIG. 18 is a diagram showing an example of a software configuration of a terminal 2′, FIG. 19 is a diagram showing an example of a functional structure of the terminal 2′, FIG. 20 shows an example of an additional information setting screen HG5, FIG. 21 shows an example of an object creation adding screen HG6, FIG. 22 is a diagram showing an example of data stored in a document database 1DC and FIGS. 23(a) and 23(b) are diagrams exemplifying a method for generating a document reproduced image FG.

In the first embodiment, a user writes additional information such as handwritten notes or the like into a sheet of an original document with a pen or the like. Then, sheets of the additional information and the original document are scanned by a scanner to register data for the original document and data for the additional information in a document database. In the second embodiment, additional information is written into an original document using application software, then to be registered in a document database. Hereinafter, a document data sharing system according to the second embodiment will be described with differences from the first embodiment being mainly described. Descriptions will be omitted with respect to similarities to the first embodiment.

An overall configuration of the document data sharing system in the second embodiment is similar to the case of the document data sharing system KSY shown in FIG. 1 according to the first embodiment. The document data sharing system in the second embodiment is referred to as a “document data sharing system KSY′ in order to distinguish the same from the document data sharing system KSY in the first embodiment. Similarly, an image forming apparatus and terminal(s) included in the document data sharing system KSY′ are referred to as an “image forming apparatus 1′” and “terminal(s) 2′”, respectively.

A hardware configuration of the image forming apparatus 1′ is the same as that of the image forming apparatus 1 in the first embodiment (see FIG. 2). The hard disk drive 10d, however, stores programs and data for realizing functions of a screen display process portion 121, an original document registration process portion 122, an additional information registration process portion 123, an output image generating portion 124, an image print process portion 125, a reproduction data transmission process portion 126, a data searching portion 127 and a document database 1DC, all of which are shown in FIG. 17.

Referring to FIG. 18, editing application software, an operating system (OS) and others are installed on a hard disk drive in the terminal 2′. A CPU of the terminal 2′ executes these programs. The operating system incorporates a driver for controlling the image forming apparatus 1′ therein. The editing application software includes programs and data for realizing functions of an original document retrieving portion 201, an original document display process portion 202, an additional information accepting portion 203, an additional information data generating portion 204 and an additional information data transmission portion 205, all of which are shown in FIG. 19.

Descriptions will be given below of functions and process contents of the portions in the image forming apparatus 1′ shown in FIG. 17 and of the portions in the terminal 2′ shown in FIG. 19.

The document database 1DC in the image forming apparatus 1′ saves original document data DTO, document name data NMO and original access privilege data RTO of an original document, similarly to the document database 1DB in the first embodiment. Further, the document database 1DC saves, in association with the original document, additional data DTA of additional information that is added to the original document, user data URA and additional information access privilege data RTA.

The screen display process portion 121 performs a process for making the display 10f1 of the control panel 10f or the terminal 2 display a screen in the same manner as the screen display process portion 101 (see FIG. 4) in the first embodiment.

The original document registration process portion 122 performs a process for inputting the original document data DTO of the original document and data for information on attributes of the original document to register the same in the document database 1DC. There are two methods for registering such data as described below.

One is the same method as that of the first embodiment. More specifically, as described earlier with reference to FIG. 6, a sheet of an original document is scanned to generate image data of the original document so that the generated image data are saved in the document database 1DC as the original document data DTO. Further, the document name data NMO and the original access privilege data RTO are saved as data for information on attributes of the original document data DTO based on contents specified by a user on the original document scan setting screen HG1 (see FIG. 7).

The other is a method for receiving a file of an original document that is generated using application software from the terminal 2′ or others to save the file thus received in the document database 1DC as the original document data DTO. In this case, a screen corresponding to the original document scan setting screen HG1 may be displayed on the terminal 2′ to prompt a user to designate contents of the document name data NMO and the original access privilege data RTO, both of which are saved together with the original document data DTO.

The additional information registration process portion 123, the data searching portion 127, and the original document retrieving portion 201 through the additional information data transmission portion 205 of the terminal 2′ cooperate with one another to perform a process for registering in the document database 1DC data on additional information such as notes that are written into an original document, for example, in the following manner.

A user performs a predetermined operation using the terminal 2′ to run editing application software while logging in to the terminal 2′. Then, the original document retrieving portion 201 in the terminal 2′ requests the data searching portion 127 to search an original document that the user can use. In requesting, a user name of the user is notified. Responding to this operation, the data searching portion 127 searches an original document that is allowed to be used by the user based on the notified user name and the original access privilege data RTO of each original document saved in the document database 1DC, then to notify the terminal 2′ that made the request of a document name of the searched original document.

Then, the original document retrieving portion 201 displays the reply (the search result) received from the image forming apparatus 1′ on a display to prompt the user to select one original document into which the user intends to make notes or others. When the user selects one original document, the original document data DTO for the selected original document are downloaded from the image forming apparatus 1′.

The original document display process portion 202 displays an image of the original document selected by the user based on the original document data DTO downloaded from the image forming apparatus 1′. The additional information accepting portion 203 accepts memorandums or others that are additionally written by the user into the original document as additional information. The user can additionally write memorandums or others into the original document, for example, in the following manner.

The user performs a predetermined operation to make the terminal 2′ display the additional information setting screen HG5 as shown in FIG. 20. The user specifies in a text box TB51 a path (a storage location) of a file for an object, i.e., a photograph, an illustration, a text or a chart, which is intended to be written into the displayed original document as additional information. The user further specifies in text boxes TB52 and TB53 a value of X coordinates and a value of Y coordinates at a position of the original document where the object is to be written, respectively.

Further, a user name of a user (a person) who wrote the additional information is specified in a text box TB54. A user who is allowed to use the additional information is specified in an access privilege given user list LT5. Specifying plural users is also possible. After completing those designations, the “OK” button is pressed. For simplicity, a user name of a user who is now logging in, i.e., a person who wrote is automatically stored as a default value in the text box TB54, similarly to the case of the first embodiment (see FIG. 10). When a user intends to designate him/her, he/she retains contents specified in the text box TB54. When the user intends to designate another user, he/she designates a user name of the other user in the text box TB54.

Responding to this operation, the additional information accepting portion 203 accepts the specified contents to instruct the additional information data generating portion 204 and the additional information data transmission portion 205 to generate data on the additional information and to transmit the generated data to the image forming apparatus 1′.

The additional information data generating portion 204 retrieves a file of the additional information based on the path specified on the additional information setting screen HG5 to add to the file the specified positional information (values of X-coordinates and Y-coordinates at a position where the additional information is to be written), so that additional data DTA are generated. The additional information data generating portion 204, further, generates user data URA indicative of a user name of a person who wrote the additional information and additional information access privilege data RTA indicative of a privilege of an access to the additional information.

The additional information data transmission portion 205 associates the additional data DTA, the user data URA and the additional information access privilege data RTA that are thus generated with the original information that is the basis thereof to transmit all the data to the image forming apparatus 1′.

Alternatively, a user can write memorandums or others into an original document as the following manner. More specifically, the object creation adding screen HG6 as shown in FIG. 21 is displayed on the terminal 2′. An image of an original document that is downloaded from the image forming apparatus 1′ is arranged on an original document image window WN6. The user operates a mouse to designate a position at which additional information should be written in the original document image window WN6. Then, an object creation area RY6 is displayed at the designated position. The user operates a keyboard or the mouse to create in the object creation area RY6 an object such as an illustration or a text that should be written as additional information.

Further, similarly to the case of the additional information setting screen HG5 shown in FIG. 20, a user name of a user who wrote the additional information, i.e., the object is specified in the text box TB6 and a user who is allowed to use the additional information is specified in the access privilege given user list LT5. After completing those designations, the “OK” button is pressed.

Responding to this operation, the additional information accepting portion 203 accepts the created object and the specified contents to instruct the additional information data generating portion 204 and the additional information data transmission portion 205 to generate data on the additional information and to transmit the generated data to the image forming apparatus 1′.

The additional information data generating portion 204 converts the created object, i.e., the additional information into data in a predetermined format. When a text is created, for example, the additional information data generating portion 204 converts the text into a text file or a rich text file. When an illustration is created, for example, the additional information data generating portion 204 converts the illustration into GIF data or TIFF data. Data of an object that was converted into a predetermined format are hereinafter referred to as “object data”. Information indicating a position of the object creation area RY6 is added to the object data as positional information of the additional information. In this way, additional data DTA are generated. Further, similarly to the case of the method for the additional information setting screen HG5, user data URA and additional information access privilege data RTA are generated. After that, the additional information data transmission portion 205 transmits all these data thus generated to the image forming apparatus 1′.

The additional information registration process portion 123 shown in FIG. 17 associates, for example as shown in FIG. 22, the additional data DTA, the user data URA and the additional information access privilege data RTA that pertain to the additional information and are received from the terminal 2′ with the original document data DTO of the original document that is the basis thereof to store all the data in the document database 1DC.

The output image generating portion 124, similarly to the output image generating portion 104 in the first embodiment, performs a process for reproducing an image of a document that a user intends to output. Procedures for this process are basically the same as the case of the output image generating portion 104 and are as described earlier with reference to FIGS. 12 and 13.

This second embodiment, however, differs from the first embodiment in a process of steps for overlaying an image of additional information on an image of an original document, i.e., steps corresponding to circled number 7 in FIG. 12 and #328 in FIG. 13 since a structure of additional data DTA in the second embodiment is different from that in the first embodiment. A process of steps prior to the overlaying steps in the second embodiment is the same as that in the first embodiment. More specifically, a user retrieves data of an original document that is specified on the display document setting screen HG3 (see FIG. 14) and data of one or more pieces of additional information that are specified on the layer setting screen HG4 (see FIG. 15). Accordingly, descriptions are given of the process of overlaying steps here.

As shown in FIG. 23(a), for example, suppose that original document data DTOa are retrieved as the original document data DTO and two sets of additional data DTAa and DTAb are retrieved as the additional data DTA of the additional information.

The output image generating portion 124 generates an image of the original document based on the original document data DTOa. Positions, in the generated image, that are indicated in positional information of the additional data DTAa and DTAb are located.

As shown in FIG. 23(b), images of the additional information are generated respectively based on object data of the additional data DTAa and DTAb. Then, these two images are overlaid on the image of the original document at the respective positions. Thus, a document reproduced image SG that is desired by a user is generated.

Referring back to FIG. 17, the document reproduced image SG thus generated is printed on a sheet of paper by the image print process portion 125 or is displayed on the display 10f1 or on the terminal 2′ by the screen display process portion 121, similarly to the case of the first embodiment.

In the meantime, when the image forming apparatus 1′ does not support a format of original document data DTO of an original document that is specified by a user on the display document setting screen HG3 or a format of object data of additional information that is specified by a user on the layer setting screen HG4, the output image generating portion 124 is incapable of generating a document reproduced image SG. In such a case, the reproduction data transmission process portion 126 transmits to the terminal 2′ the original document data DTO of the original document and the additional data DTA of the additional information, both of which are specified by the user. After receiving the data, the terminal 2′ performs a process similar to the process described with reference to FIG. 23 to generate a document reproduced image SG.

Here, simple descriptions are provided of procedures of the entire process in the image forming apparatus 1′ according to the second embodiment. The entire process procedures of the image forming apparatus 1′ during a period from user's logging in to user's logging out are basically the same as the case of the first embodiment and are almost the same as the procedures described earlier with reference to FIG. 16. As described above, however, since the structure of additional data DTA in the second embodiment is different from that in the first embodiment, the second embodiment differs from the first embodiment in the process methods of steps #5 and #7. When a user performs an operation for outputting a document (Yes in #6), provided that formats of necessary data are not supported by the image forming apparatus 1′, the data are transmitted to the terminal 2′ of the user and the terminal 2′ performs the process of steps #7 and #8.

The second embodiment enables additional data DTA of additional information to be registered in the image forming apparatus 1′ even when the additional information is written into an original document using a personal computer or the like in an electronic manner.

Accordingly, as is the case with the first embodiment, it is possible to manage the additional data DTA easily even if data for much additional information are registered for one original document or even if additional information that needs to be concealed from a predetermined user should be registered.

Although a user uses the terminal 2′ to perform a creation process of additional information and a designation process with respect thereto in the second embodiment, a configuration is possible in which such processes can be performed in the image forming apparatus 1′. In such a case, all the functions of the terminal 2′, which are shown in FIG. 19, may be provided in the image forming apparatus 1′.

In the first and second embodiments, information indicative of a user name of a person who wrote additional information is added as user information of additional data DTA of the additional information. It is possible, however, to add information indicative of other matters. For example, information can be added which indicates a department to which a person who wrote belongs and a post of the person. Alternatively, information can be added which indicates creation date and time or importance of additional information.

Furthermore, the configuration of the entire or a part of the document data sharing system KSY or KSY′, the image forming apparatus 1 or 1′, the terminal 2 or 2′, the process contents, the process order, the contents of the databases and the like can be modified in accordance with the spirit of the present invention if necessary.

The present invention can be suitably used for converting into electronic data additional information written by each user into a document that is generated by duplicating one document and is distributed to many users and for managing the data. More particularly, the present invention can be suitably used for converting into electronic data additional information that is written into materials for meeting or into paper of model form for applications to manage the data.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A document data management system, comprising:
a first data entry process portion for performing a process for entering original image reproduction data used for reproducing an image of an original of a document;
a second data entry process portion for performing a process for entering additional information image reproduction data used for reproducing an image showing additional information that is information added to the document;
a setting portion for setting an access privilege of the additional information; and
a memorizing portion for memorizing, in association with one another, the original image reproduction data thus entered of the document, the additional information image reproduction data thus entered of the additional information for the document and access privilege data indicating the access privilege thus set of the additional information.

2. The document data management system according to claim 1, further comprising
a presenting portion for presenting the additional information corresponding to the additional information image reproduction data that are memorized in the memorizing portion in order to prompt a user to select, the additional information to be presented being associated with the document specified by the user and the additional information to be presented being capable of being accessed by the user,
a combined image generating portion for generating a combined image that is an image in which one or more images of one or more pieces of the additional information are overlaid on the image of the original of the document based on the original image reproduction data of the document specified by the user and the additional information image reproduction data of the one or more pieces of the additional information selected by the user, and
an output process portion for performing a process for outputting the combined image thus generated.

3. The document data management system according to claim 1, wherein
the first data entry process portion performs the process for entering the original image reproduction data for the document by scanning a sheet of the original of the document with a scanner, and
the second data entry process portion performs the process for entering the additional information image reproduction data for the additional information for the document by determining a difference between an image that is obtained by scanning with the scanner the sheet of the document into which the additional information is written and an image that is obtained by scanning the sheet of the original of the document in a state before the additional information is written.

4. The document data management system according to claim 1, wherein the second data entry process portion performs a process for entering, as the additional information image reproduction data for the additional information for the document, data including positional information indicating a position of the image of the additional information on the image of the original of the document and object data of the additional information that is created by a user using application software.

5. The document data management system according to claim 1, wherein the second data entry process portion performs a process for entering, as the additional information image reproduction data for the additional information for the document, data including positional information indicating a position of the image of the additional information on the image of the original of the document and object data of the additional information that is retrieved from a storage location specified by a user.

6. An image forming apparatus that is configured to have an image reading portion and a printing portion, the image forming apparatus comprising:
a first read control portion for making the image reading portion read an image of an original of a document;
a second read control portion for making the image reading portion read an image of the document into which information is written;
a first image generating portion for generating an additional information image that is an image showing only the written information by determining a difference between the image of the original of the document and the image of the document into which the information is written;
an access privilege setting portion for setting an access privilege to the additional information image thus generated;
a document data memorizing portion for memorizing, in association with one another, original image data that are image data of the image of the original of the document, additional information image data that are image data of the additional information image of the information that is written into the document and access privilege data indicating the access privilege thus set of the additional information image;
a presenting portion for presenting the written information corresponding to the additional information image data that are memorized in the document data memorizing portion, in order to prompt a user to select, the information to be presented being associated with the document specified by the user and the information to be presented being capable of being accessed by the user;
a second image generating portion for generating a combined image that is an image in which one or more images of one or more pieces of the written information are overlaid on the image of the original of the document based on the original image data of the document specified by the user and the additional information image data of the one or more pieces of the written information selected by the user; and
a print control portion for controlling the printing portion to print the combined image thus generated on a sheet of paper.

7. A document data management method for managing data used for reproducing an image of a document, the method comprising:
entering original image reproduction data used for reproducing an image showing an original of the document;
entering additional information image reproduction data used for reproducing an image showing additional information that is information added to the document;
setting an access privilege of the additional information; and
making a memorizing portion memorize, in association with one another, the original image reproduction data thus entered of the document, the additional information image reproduction data thus entered of the additional information for the document and access privilege data indicating the access privilege thus set of the additional information.

8. The document data management method according to claim 7, further comprising
presenting the additional information corresponding to the additional information image reproduction data that are memorized in the memorizing portion, in order to prompt a user to select, the additional information to be presented being associated with the document specified by the user and the additional information to be presented being capable of being accessed by the user,
generating a combined image that is an image in which one or more images of one or more pieces of the additional information are overlaid on the image of the original of the document based on the original image reproduction data of the document specified by the user and the additional information image reproduction data of the one or more pieces of the additional information selected by the user, and
performing a process for outputting the combined image thus generated.

9. The document data management method according to claim 7, wherein
the process for entering the original image reproduction data for the document is performed by scanning a sheet of the original of the document with a scanner, and
the process for entering the additional information image reproduction data for the additional information for the document is performed by determining a difference between an image that is obtained by scanning with the scanner the sheet of the document into which the additional information is written and an image that is obtained by scanning the sheet of the original of the document in a state before the additional information is written.

10. The document data management method according to claim 7, further comprising performing a process for entering, as the additional information image reproduction data for the additional information for the document, data including positional information indicating a position of the image of the additional information on the image of the original of the document and object data of the additional information that is created by a user using application software.

11. The document data management method according to claim 7, further comprising performing a process for entering, as the additional information image reproduction data for the additional information for the document, data including positional information indicating a position of the image of the additional information on the image of the original of the document and object data of the additional information that is retrieved from a storage location specified by a user.

12. A recording medium for storing a computer program for use in a computer that manages data used for reproducing an image of a document, the computer program makes the computer execute the processes comprising:
entering original image reproduction data used for reproducing an image showing an original of the document;
entering additional information image reproduction data used for reproducing an image showing additional information that is information added to the document;
setting an access privilege of the additional information; and
making a document data memorizing portion memorize, in association with one another, the original image reproduction data thus entered of the document, the additional information image reproduction data thus entered of the additional information for the document and access privilege data indicating the access privilege thus set of the additional information.
